(19) United States
(12) Patent Application Publication
(10) Pub. No.: US 2003/0039448 A1
(43) Pub. Date: Feb. 27, 2003

(54) Method and apparatus for tuning an optical device

(76) Inventors: Thomas Hua Diem Ting, Marsfield (AU); David C. Psaila, Chifley (AU); Laurence Reekie, Wahroonga (AU)

Correspondence Address: Jeff Klembczyk, Intellectual Property Dept., JDS Uniphase Corporation, 570 West Hunt Club Road, Ottawa, ON, CA

(21) Appl. No.: 10/218,016

(22) Filed: Aug. 14, 2002

(30) Foreign Application Priority Data
Aug. 15, 2001 (AU) PR 7024

(51) Int. Cl. G02B 6/26; G02B 6/34

(52) U.S. Cl. 385/43; 385/147; 385/37

(57) ABSTRACT

The present invention relates to a method and apparatus for tuning an optical fiber based optical device. An optical fiber device in accordance with the present invention is held at a first tension, and in accordance with the method of the present invention, heat is applied to the fiber to cause a release of tension. This can be used effectively to provide accurately tuned in-fiber Bragg gratings, or to trim fiber based interferometers. Advantageously, tuning method is significantly simplified over prior art methods. A further advantage is realized in that multiple fiber Bragg gratings can be packaged together and tuned separately, including multiple fibers or multiple gratings in a single fiber.

### FIELD OF THE INVENTION

The present invention relates to a method and apparatus for tuning an optical fiber based optical device, to an optical device so tuned, and particularly, but not exclusively, to a method and apparatus for tuning the wavelength of an in-fiber Bragg grating or long period grating and to a Bragg grating so tuned.

### BACKGROUND OF THE INVENTION

In-fiber Bragg gratings are well known optical devices. They have many applications in optical systems. They normally comprise a repeating pattern written into a photosensitive optical fiber by a UV light source. They are optically reflective at a particular wavelength, termed the “wavelength”. They have significant applications, particularly in wavelength division multiplexing optical systems.

An in-fiber Bragg grating is inherently highly sensitive to the effects of tension on the fiber. A change in tension changes the wavelength. The change in tension does not have to be of large magnitude to cause a change in wavelength that can deleteriously affect the required operation of the Bragg grating. In-fiber Bragg gratings are therefore usually mounted in a “package” designed to hold the Bragg grating at a pre-determined, accurately defined tension.

Bragg grating packages are of sophisticated design. Because they must maintain the Bragg grating at a very specific tension, they must be designed to take into account temperature fluctuations and other environmental factors, and compensate for them. The present applicants have lodged a number of patent applications to various aspects of Bragg grating packages. U.S. Pat. No. 6,393,181, issued May 21, 2002 and entitled “Temperature Stable Bragg Grating Package with Post Tuning For Accurate Setting of Center Frequency”, the disclosure of which is incorporated herein by reference, discloses a particular type of Bragg grating package which is adapted to compensate for fluctuations in temperature and maintain the in-fiber Bragg grating at the required tension. International Patent Application No. PCT/AU01/00055 lodged on Jan. 19, 2001, titled Photonic Device Package, the disclosure of which is incorporated herein by reference, discloses a Bragg Grating Package which utilizes glass solder to anchor the in-fiber Bragg grating. The supports mounting the glass solder have a coefficient of thermal expansion that is higher than that of the glass solder, in order that compression might be induced in the glass solder during post-fusion solidification. The use of glass solder has significant advantages over the use of epoxy to anchor in-fiber Bragg gratings.

It will be appreciated that the setting of the tension of the fiber when it is mounted into the package is critical. It has been found that it is difficult to hold the fiber at the required tension for the pre-determined wavelength and then subsequently mount the fiber in the package while maintaining the required tension level. The tension could invariably change as the fiber is mounted into the package. To overcome this problem, it is known to first mount the fiber in the package and then “tune” the fiber by altering the tension as the fibre sits in the package.

This “post-tuning” of in-fiber Bragg gratings can be done in a number of ways. One arrangement is utilizing adjustable screws to flex the package and thereby change the tension on the fiber. See, for example, U.S. Pat. No. 6,181,851. This arrangement is not very accurate, and also the tension exerted on the fiber can change over time.

Another method, proposed earlier by the applicants, is to initially pre-set the strain on the fiber to achieve a wavelength which is lower than the desired wavelength. The fiber is placed into a package, which is of a material that is plastically deformable. INVAR is a low expansion metallic alloy that is particularly suitable. There are also other materials that are suitable for this purpose. The package itself is then stretched or compressed to bring about a permanent deformation in the length of the package and the attached fiber, which is used to adjust the tension on the fiber to achieve the desired wavelength.

A problem with this arrangement is that hundreds of kilos of load are required to deform materials such as INVAR and large, sophisticated machines are required to apply the deformation force precisely enough to ensure that the correct tension is supplied. A further problem is that each batch of a material such as INVAR will be slightly different so that the deforming machines will have to be re-programmed for each batch.

Note that an alternative method of proceeding is to pre-set the tension of the grating to a tension which provides a higher wavelength than the desired wavelength, place the grating in the package and then deform the package by compressing it to relieve the tension on the grating. Again, machines required to deform the packaging compressively are sophisticated and expensive.

Another problem with the prior art methods is that only a single fiber may be held and tuned per package. Because the packages are deformed, or flexed, or put under tension in order to tune the Bragg grating, it is not possible to tune a number of Bragg gratings independently in the same package. Using the method described above, servicing each grating will usually require a different tension to be tuned to its correct wavelength. They will all invariably be tensioned to tensions that do not give the desired wavelength if the package is deformed or flexed to have one of the fibers achieve the wavelength. Conventionally therefore, each fiber must be provided with its own separate package, and must be separately tuned, all of which adds significantly to the expense of in-fiber Bragg gratings

There is a need for an alternative approach to wavelength tuning of packaged Bragg gratings and other optical devices that require accurate setting in wavelengths.

### SUMMARY OF THE INVENTION

In accordance with the first aspect of the present invention there is provided a method of tuning an in-fiber optical device, the fiber being held at a first tension, comprising the step of applying heat to the fiber to cause a release of tension to adjust the tension of the fiber to a second tension.

Preferably, the heat is applied to a localized area or localized areas of the fiber

Preferably, the device is an in-fiber Bragg grating.

Preferably, the device is held at the first tension within a mounting package. Preferably, heat is applied by way of a laser. Preferably, the laser is of a wavelength that is absorbed to some degree by the fiber material.

Preferably, heat is applied in such a way to a localized area or localized areas of the fiber to result in tapering of the fiber in that area, resulting in a release of tension on the fiber. This causes the wavelength of the grating to shift without significant alteration of the wavelength profile.

The process of the present invention has an advantage that tuning of the device can be achieved without deformation or flexing of the packaging. It can therefore be achieved without the necessity of complicated machines or the use of screws or other means, which may allow the undesirable release of tension over time. Of course, it will be appreciated that the method of the present invention may be used in addition to the prior art tuning methods, for example, to assist in highly accurate tuning of an in-fiber Bragg grating.

Yet a further advantage of the present invention is that it can be applied to tune a plurality of fibers mounted in a single package. Because it is not necessary, or at least not primarily necessary to use deformation of the package to tune the fibers, each fiber can be tuned separately by the method of the present invention. Use of the present invention can therefore enable a package to mount a plurality of tuned fibers.

Yet a further advantage of the present invention is that it can also be applied to tune multiple gratings in a single fiber. For example, a single length of fiber may be provided with several Bragg gratings or long period gratings. Each section of the fiber containing a grating can be separately pre-tensioned (eg by perhaps having multiple solder joints). The method of the present invention can then be applied to tune the wavelengths of each of the gratings as appropriate. The present invention also preferably enables a package, which incorporates a plurality of fibers, where one, or more of the fibers may include a plurality of gratings

Yet a further advantage of the present invention is that it allows tuning to wavelength gratings mounted in packages of material that cannot be mechanically deformed (eg ceramics or other brittle materials). Cheaper materials than INVAR, for example, can therefore be utilized for packaging

In accordance with a second aspect of the present invention, there is provided an optical fiber device comprising an optical fiber; a spaced apart pair of fixed supports for supporting a length of the optical fiber under tension, the length of optical fiber under tension including a portion exposed for heating, the portion having a taper, whereby in response to heat on the portion of the length of optical fiber under tension, the tension can be controllably reduced to tune the optical fiber device.

In accordance with a third aspect of the present invention, there is provided a packaged optical device comprising an in-fiber optical device including an exposed portion for heating having a taper therein; a package for hermetically sealing the in-fiber optical device, a plurality of supports in fixed position within the container for supporting the in-fiber optical device under tension, whereby the in-fiber optical device can be tuned by heating.

In accordance with a fourth aspect of the present invention, there is provided an optical device comprising a plurality of tuned in-fiber gratings mounted in a single package.

Preferably, each of the plurality of gratings is tuned utilizing the method of the first aspect of the present invention.

The in-fiber gratings may be provided in a plurality of separate fibers mounted in the single package. Alternatively, or in addition, a plurality of gratings may be provided in a single fiber mounted in the package.

The gratings may be Bragg gratings or long period gratings.

An apparatus for tuning an in-fiber optical device comprises a heating device arranged to apply heat to a fiber under tension in order to soften the fiber and cause tension to be reduced, whereby to tune the wavelength of the device.

Preferably, the heating device is arranged to heat the fiber in a localized area or a plurality of localized areas.

In a preferred embodiment the heating device is a laser including a controller programmed appropriately to cause heat to be applied to the fiber in a pre-determined manner. Preferably, active feedback control is applied, enabling adjustment of the heating exposure timing and levels to achieve desired shifts in wavelength. This wavelength tuning system may be operated either automatically or with minimal external involvement during the tuning process.

A computer program arranged, when loaded onto a computing device causes the computing device to control the heating device to apply heat to an in-fiber optical device in order to tune the device, heat being applied in a predetermined manner according to the control instructed by the program.

Preferably, control is provided via a feedback control system in order to actively tune the device.

Packages for in-fiber devices, such as in-fiber Bragg gratings usually include an enclosed housing to protect the in-fiber device from the environment. In order to facilitate the present invention, a package preferably needs to be provided which includes means enabling access to a heating device for applying an appropriate amount of heat to the fiber in order to tune the device.

### BRIEF DESCRIPTION OF THE DRAWINGS

Features and advantages of the present invention will become apparent from the following description of an embodiment thereof, by way of example only, with reference to the accompanying drawings, in which:

FIG. 1 shows an enlarged scale sectional elevation view of assembled carrier fiber support components of a packaged in-fiber grating in accordance with the applicant's earlier patent application PCT/AU01/00055;

FIG. 2 shows a sectional elevational view of the assembly of FIG. 1 mounted within a protective sleeve;

FIG. 3 shows (further enlarged) a cross-sectional view of the assembly as seen in the direction of section plane 3-3 in FIG. 1;

FIG. 4 shows (still further enlarged) a perspective view of a portion of one of the supports when removed from the package;

FIG. 5 is a schematic diagram of an arrangement in accordance with an embodiment of the present invention for tuning an in-fiber Bragg grating, and a package in accordance with an embodiment of the present invention for an in-fiber Bragg grating.

FIG. 6 is a graph showing shifts in reflection wavelength spectra from tuning an in-fiber Bragg grating using an arrangement in accordance with an embodiment of the present invention, and

FIG. 7A is a schematic diagram of a Mach-Zehnder interferometer device that is arranged to be tuned in accordance with an embodiment of the present invention.

FIG. 7B is a schematic diagram of a Michelson interferometer device that is arranged to be tuned in accordance with an embodiment of the present invention.

FIG. 7C is a schematic diagram of a Sagnac interferometer device that is arranged to be tuned in accordance with an embodiment of the present invention.

FIG. 8 is a schematic plan view of the location of an oxygen/methane torch relative to a fiber located in a package.

FIG. 9 is a graph of tuning change in center wavelength versus accumulated heating time in seconds.

### DETAILED DESCRIPTION OF PREFERRED EMBODIMENTS

For the purposes of illustration, a packaging arrangement for an in-fiber Bragg grating will now be described. This arrangement is described in detail in the applicants' international patent application referred to above.

As illustrated, the photonics device package comprises two longitudinally spaced-apart supports 10 for a length of optical fiber 11. The supports 10 are located within opposite ends of a carrier 12 through which the optical fiber 11 extends, and the carrier 12 is located within a protective sleeve 13.

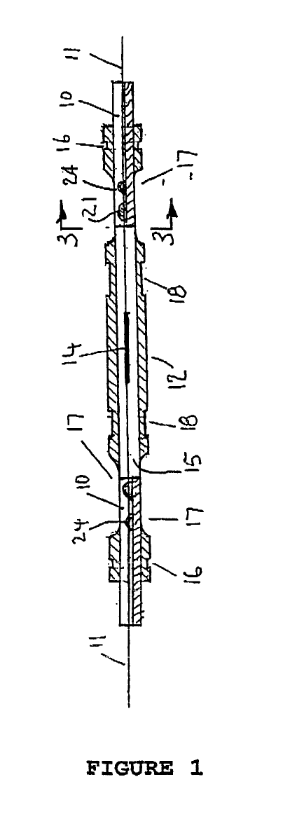

The optical fiber 11 is formed within a portion of its length with a Bragg grating that is indicated schematically in FIG. 1 by the exaggerated fiber thickness 14, and the grating-containing portion of the optical fiber that extends between the supports 10 is loaded in tension to an extent required to impose a requisite degree of strain in the grating-containing region of the fiber. The level of strain that is imposed will be dependent upon that required to tune the grating to a selected center wavelength The carrier 12 is formed from a rod of low expansion material such as Invar and it is provided with a central bore 15 through which the optical fiber 11 extends. The supports 10 are located within the bore 15 and are held in place by welding through the carrier 12 at end regions 16.

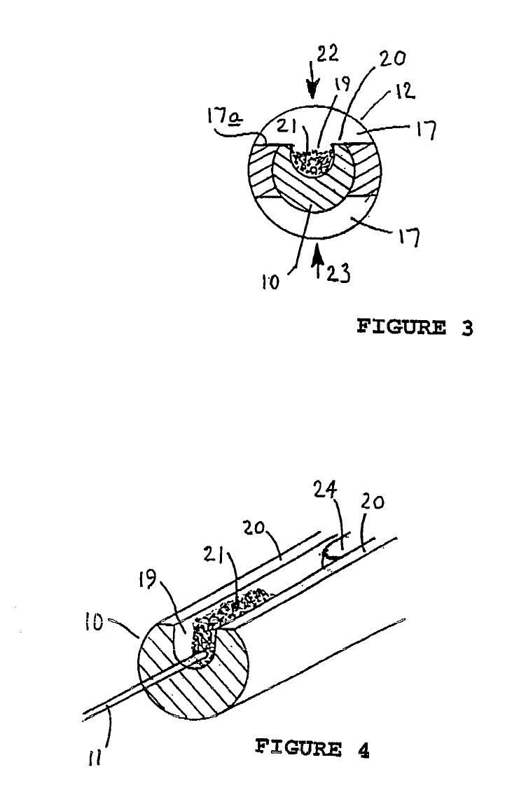

Two diametrically opposed elongated openings 17 are provided adjacent each end of the carrier, and two longitudinally spaced, circumferential grooves 18 are provided to facilitate gripping of the carrier. As is most clearly shown in FIGS. 3 and 4 each of the supports 10 comprises a generally cylindrical element that is formed along its full length with a longitudinally extending groove 19. Also, the supports 10 are formed with flat lips 20 at each side of the groove, to coincide with side lands 17a of the upper openings 17.

The supports 10 can be formed from stainless steel, aluminum, or any other material with a suitable Coefficient of Thermal Expansion.

The groove 19 within each support 10 has a depth that is approximately equal to the radial dimension of the support. The optical fiber 11 is nested in the groove 19 in each of the supports 10 and is anchored in place by a deposit 21 of glass solder. There are two methods of attaching the optical fiber to the supports.

In the first method, glass solder 21 is deposited in each of the grooves 19 after the optical fiber has been extended through the carrier 12, and the glass solder is subjected to localized heat. The glass solder is deposited within each of the grooves 19 by way of the upper openings 17 and, thus in the direction of arrow 22. The fusing heat for the glass solder is applied by focusing a CO₂ laser beam in the direction of arrow 23 through the openings 17 and against the underside of each of the supports 10. Thus, the glass solder is fused by heat applied by way of the supports, this providing for good wetting of the solder-to-supports and minimizing the risk of damage to the optical fiber. Of course, the normal acrylate (plastics material) cladding is removed from the portions of the length of the optical fiber that are to be embedded within the solder glass deposits, in order to provide for solder-to-glass contact.

In the second method, the glass solder 21 is deposited in the grooves and the fusing heat is applied to melt the solder. The package is then raised so that the suspended optical fiber 11 is immersed in the glass solder within the grooves 19. Alternatively, the optical fiber 11 can be lowered into the glass solder within the grooves 19 when the glass solder is molten. Once the fiber has wetted to the solder, the heat is reduced to allow the solder to solidify, thus bonding the fiber to the supports 10.

During the period when the glass solder frit is fusing and subsequently solidifying, the optical fiber is held under light tension, just sufficient to hold the fiber slightly above the base of the grooves 19 and to permit the free flow of molten glass solder around the optical fiber.

In order to protect the packaged fiber from any external load that might be applied to the optical fiber, a plastics material clad portion of the optical fiber is anchored within the groove 19 of each of the supports 10 by a deposit 24 of acrylate resin. The resin deposit is cured by exposure to UV radiation.

Following anchoring of the optical fiber 11 within the grooves 19 in the supports 10 and fixing the supports to the carrier, the assembly as illustrated in FIG. 1 is gripped by way of the grooves 18 and is subjected to an elongating tensile load. The carrier 11 and the grating-containing portion of the optical fiber are thereby elongated to an extent sufficient to induce a required level of strain into the grating-containing portion of the optical fiber. Alternatively the supports may be moved relative to the carrier to adjust the tension on the grating before fixing the supports to the carrier. The required level of strain to be induced in the optical fiber is detected by launching an optical signal into the fiber and detecting for peak reflectance of the grating at the required center wavelength.

Having tuned the grating, the assembly as shown in FIG. 1 is inserted into the sleeve 13 and is enclosed by ends caps 25 that are press-fitted to end regions of the sleeve 13.

As discussed above, there are a number of problems associated with having to deform a device package in order to tune the device

While this package is therefore advantageous for a number of reasons (in particular because it facilitates the use of glass solder) it would be useful if the need for deformation of the package could be avoided or reduced

It will be appreciated that there are many different types of packages for in-fiber optical devices, and the present invention can be applied to all in-fiber optical devices and is not limited to being applied to devices having packages such as shown in FIG. 1.

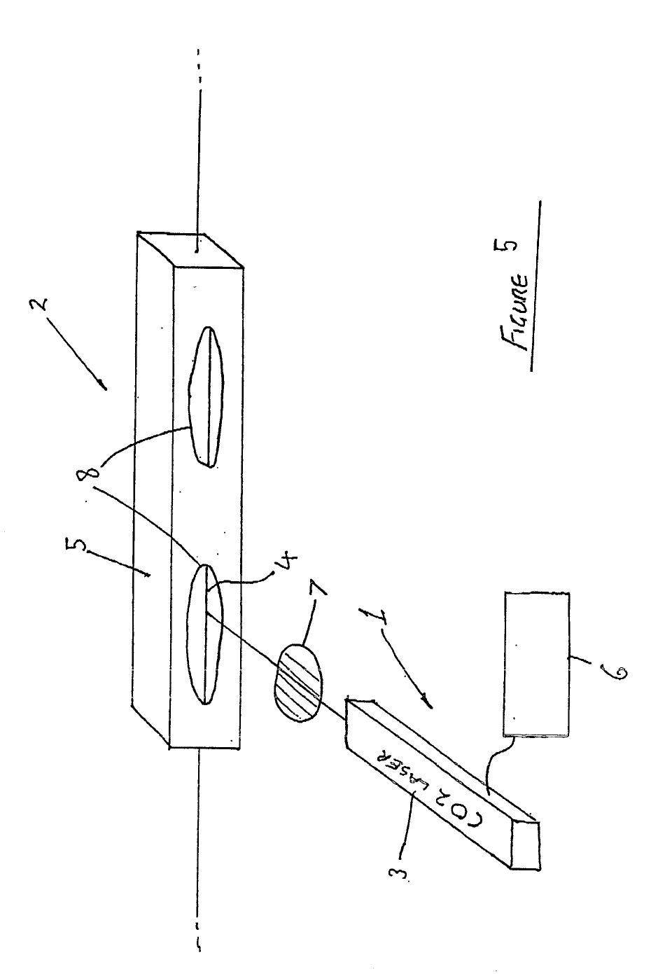

FIG. 5 illustrates an apparatus in accordance with an embodiment of the present invention for tuning an in-fiber device, generally designated by reference numeral 1, and also schematically shows an in-fiber device being tuned, generally designated by reference numeral 2.

The apparatus for tuning the fiber 1 comprises a heating device 3 which; in this embodiment, is a CO₂ laser. The CO₂ laser 3 is arranged to apply heat to a fiber 4 which is mounted in a package 5 under a first tension. In this embodiment, the fiber 4 includes an in-fiber Bragg grating device with the package 5. The application of heat to the fiber 4 causes softening of the fiber in the region where the heat is applied and a consequent release in tension.

Preferred laser heating of the fiber requires CO₂ laser power output levels to provide a power density at the fiber for absorption, sufficient to soften the fiber and change the tension, and hence wavelength of the grating. Typical power densities should provide the equivalent of 13 to 18 watts of output laser power focused through a lens to a 2 mm spot size at the fiber, as used to obtain the results presented in this patent. The heat is delivered in a 1 second ramp up and 1 second ramp down “pulse” with no dwell when the set-point laser output is reached. Heat is also delivered only to one side of the fiber. A dry nitrogen gas shield is maintained over the tapered area throughout the tapering process. Other combinations of laser output power; spot sizes and pulse shapes may also be used to achieve adequate power densities and change in tension on the grating. The heat is applied in a controlled manner so as to release the tension on the fiber 4 by a pre-determined amount to establish a final tension at which the fiber is held. The final tension corresponds to a strain on the Bragg grating resulting in the desired center wavelength.

The control system 6 for the laser is preferably configured to ensure softening of the material occurs for a sufficient period of time to a sufficient degree to enable the necessary wavelength shift in the grating to be achieved without compromising the strength of the fiber or the insertion loss in the fiber at wavelengths other than within the band of the grating.

This may be achieved by pulsing of the CO₂ laser (but 25 it is not essential that the laser is pulsed).

In one embodiment, feedback control may be employed to drive the CO₂ laser. This may include dynamic (on the order of 10 seconds or less) wavelength measurements This involves measuring the wavelength of the grating, comparing it to the target wavelength and then controlling the power output and/or the length of the next pulse of the CO₂ laser to achieve the desired shift in wavelength.

In this embodiment the apparatus for tuning the fiber comprises the CO₂ laser 3, control means 6, which may be a suitably programmed PC, for example, and focusing optics 7 for focusing the laser on a localized area of the fiber 4.

The device package 5 may be any typical package. It may be similar to the package described above in relation to FIG. 1, for example. In such a case, however, there may not be the necessity for a thinned area as there may be no need for deformation of the package to tune the fiber. Of course, in some cases it may be desirable to use a deformation technique for tuning in addition to the heating technique of the present invention and in such a case an appropriate package 5 would be utilized.

In order to enable heat to be applied to the fiber 4 however, the package 5 includes openings in the form of windows 8. There may be a single window, but in this embodiment two windows are provided. Alternatively, the package may be sealed after tuning.

Another package which can be utilized with the present invention includes a package with a single, uniform coefficient of expansion substrate with solder joints for the grating and access openings for localized heat application on the fiber.

Note that the tuning may occur by heating the fiber 4 at different portions of the fiber. To achieve this, either the optics 7 of the laser may be moved or the package 5 may be moved, or an optical arrangement for splitting the beam and simultaneously irradiating multiple locations may be used.

Further, instead of irradiating from one side, the laser beam could either be rotated or the fiber rotated or an annular ring be used to deliver the beam uniformly around the axis of the fiber.

### Example 1

The following is a description of an example of wavelength tuning of in-fiber Bragg grating using the arrangement illustrated in FIG. 5. When using the embodiment in procedures described in the previous section, the following results were obtained.

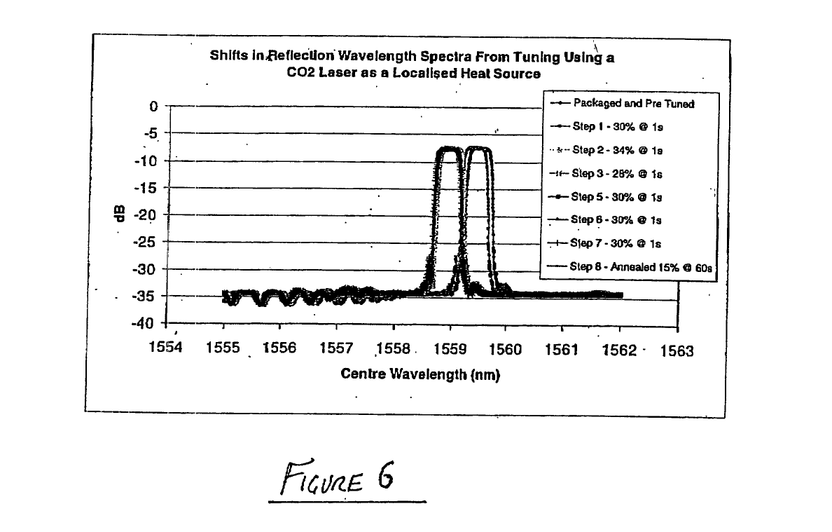

Results for the tuning of a packaged grating using a 50 Watt CO₂ laser as a localized heat source are shown in FIG. 6. The bare fiber was exposed to sequential exposures of focused light at the power settings shown in the legend on the graph. The laser spot size at the fiber was 2 mm in diameter and the laser output power setting as a percentage of the peak output power of 50 Watts with ramp-up and ramp-down times is also shown in the last three columns of Table 1.

From FIG. 6, it is clearly shown that the reflected spectra shift down after each exposure. Table 1 summarizes the center wavelength and corresponding bandwidth measured 3 dB from the peak after each exposure. Columns 3 and 4 show the incremental and cumulative shifts in center wavelength while the last three columns show the power setting and ramp up/ramp down times for the “pulse” respectively.

| | | Shift in | | CO₂ Laser | | |
|---|---|---|---|---|---|---|
| | Center | Center | Total | Output | | Ramp |
| | Wavelength | Wavelength | Cumulative | Power | Ramp Up | Down |
| | (nm) | (nm) | Shift (nm) | (% of 50 W) | Time (s) | Time (s) |
| Initial | 1559.477 | — | — | — | — | — |
| Step 1 | 1559.397 | −0.080 | −0.080 | 30% | 1 | 1 |
| Step 2 | 1558.956 | −0.441 | −0.521 | 34% | 1 | 1 |
| Step 3 | 1558.952 | −0.004 | −0.525 | 28% | 1 | 1 |
| Step 4 | 1558.941 | −0.011 | −0.536 | 29% | 1 | 1 |
| Step 5 | 1558.926 | −0.026 | −0.551 | 30% | 1 | 1 |
| Step 6 | 1558.919 | −0.007 | −0.558 | 30% | 1 | 1 |
| Step 7 | 1558.901 | −0.018 | −0.576 | 30% | 1 | 1 |

Table 1 Summary of Center Wavelength shifts after each CO₂ exposure step, cumulative shifts and operating conditions of heating using the CO₂ laser.

The final target center wavelength of 1588.900 nm±0.005 nm was reached with a total wavelength reduction of −0.576 nm.

### Example 2

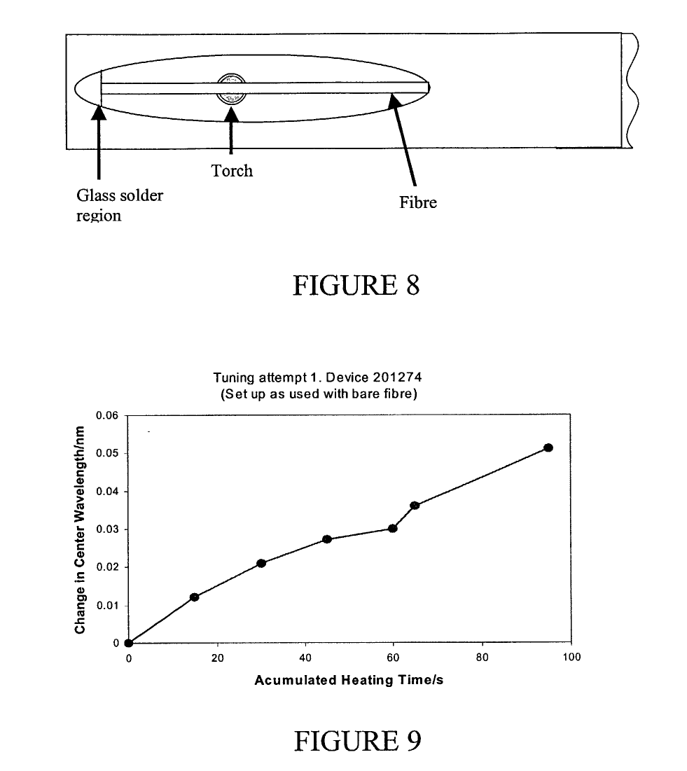

The following is a description of another device for applying heat that can be used to tune the wavelength of an optical device in accordance with the present invention. The method uses a Methane/Oxygen torch or flame in place of a laser for heating the same packaged grating as described above in Example 1. A schematic plan view of the flame relative to the fiber is shown in FIG. 8.

The torch was brought up to within the desired position (1.75 mm) below the fiber, accessed through the window in the suspended package. Care was taken to ensure that the torch was well away from the glass-soldered region holding the fiber, and held there for typically 10 seconds. Approximately 5 minutes was needed after heating to allow the center wavelength to stabilize, then a final wavelength measurement was carried out using a Swept Wavelength Measurement System.

The center wavelength shifts plotted against the exposure time of the bare fiber to the Oxygen/Methane torch are shown in FIG. 9. The observed changes in center wavelength proved that tapering of fiber using a torch/flame could provide permanent change in tension on the fiber hence changing the wavelength of the grating.

As well as tuning single fibers in packages, the present invention is also applicable to tuning multiple fibers stored in a single package. The present invention thus allows for the development of packages containing a plurality of in-fiber devices.

The present invention is also applicable to tuning multiple in-fiber devices within a single fiber, within a single package. For example, single length of fiber may be provided with several Bragg gratings or long period gratings. Each section of the fiber containing a grating can be separately pre-tensioned (eg. by perhaps having multiple solder joints). The method of the present invention can be applied to tune the wavelengths of each of the gratings as appropriate.

The specific embodiment described above has been applied to in-fiber Bragg grating. The method of tuning in the present invention may be applied to any optical device where setting of a tension of the device is important in tuning. It is not limited to in-fiber Bragg gratings, for example, long period gratings may also benefit from wavelength tuning using the method of the present invention.

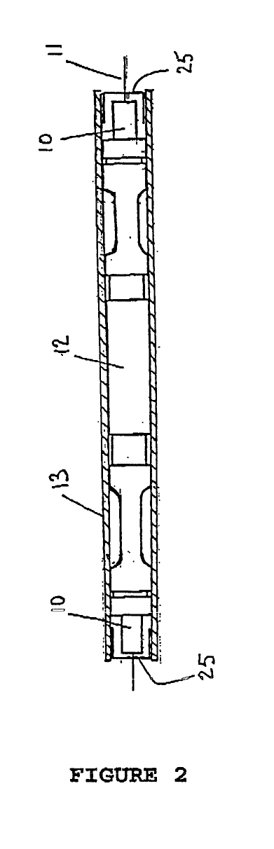

In the prior art package illustrated in FIGS. 1 through 4, moveable supports are used in assembly of the package. This is a fairly complex arrangement. It would be much simpler if the package were provided with fixed supports and then the fiber placed into the assembly. Applying the glass solder to a pre-assembled package, however, results in the fiber being placed under a large strain due to the fact that the high temperature required to melt the glass results in the supports expanding and then contracting after they've cooled down (with the fiber fixed). This can result in so much strain on the fiber that the fiber may break after a time. Utilizing the present invention, however, a fixed support package can be used, and the excess strain on the fiber can then be released.

Note that a Bragg grating tuned in accordance with the present invention could be of the form of a single, multiple, chirped and/or sampled nature.

Note that other heating devices than lasers can implement the heating step of the method of the present invention. Alternative sources of heating include hydrogen flame(s), electric arc(s), tungsten wire element and others.

As discussed above, the present invention is not limited to use with packages such as the package described in relation to the embodiment of FIGS. 1 to 4. It can be used for tuning of in-fiber devices mounted within any type of package. Thus, it is possible to tune to any wavelength, gratings mounted in non-deformable packages, for example of ceramics or other materials (which may be cheaper than Invar).

As discussed above, the method of tuning of the present invention may be applied to other optical devices.

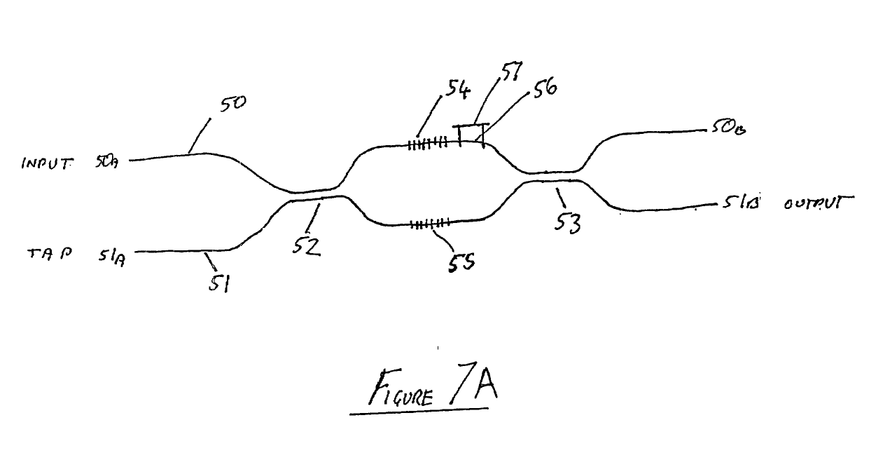

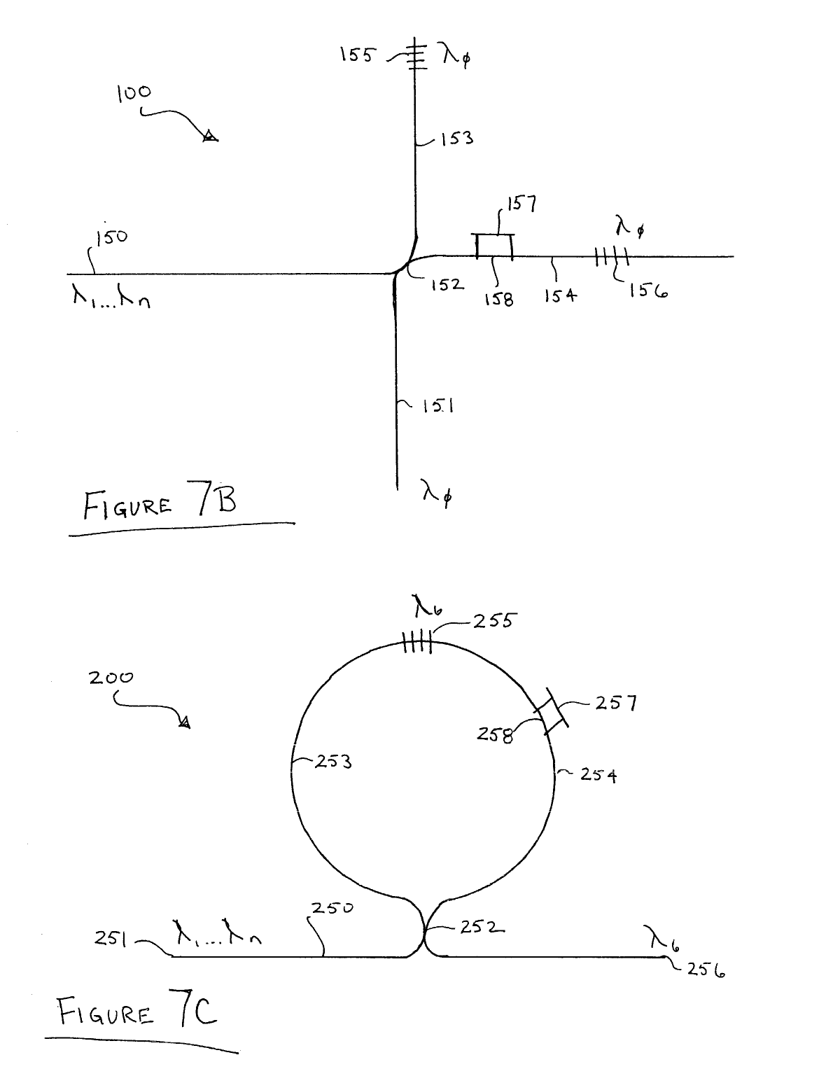

FIG. 7A schematically illustrates a Mach-Zehnder interferometer based multiplexer/demultiplexer arrangement. The device comprises a pair of optical fibers 50, 51 formed in a Mach-Zehnder arrangement, and including 3 dB fused couplers 52 and 53. Bragg gratings 54, 55 are incorporated in the interferometer arms.

In FIG. 7A, the device is shown operating as a demultiplexer. A plurality of wavelengths (λ1 . . . λ7) are launched into the input port 50A. Assuming the grating resonant wavelength 54, 55 is λ4, light at λ4 emerges from the tap 51A. The remaining light emerges from the output port 51B.

As it will be understood by a skilled person, because of the inherent symmetry of the device it is also possible to use the device as a multiplexer.

In manufacture of such a device, there will typically be a small path length difference between the two arms of the interferometer. This needs to be nulled in order to balance the interferometer. In the prior art, as for example, Kashyap et al., “Laser Trimmed Four Port Bandpass Filter Fabricated in Single Mode Photosensitive Ge-Doped Planar Waveguide”, IEEE Photonics Technology Letters, Vol 5, No 2, February 1993, pp 191-194, this has 20 been achieved by exposing one arm of the interferometer to uniform UV light to change the refractive index (RI) in the fiber core. Utilizing the present invention, trimming may be achieved in another way. A portion 56 of one of the arms of the interferometer is held at tension by a device 57. This device may include any suitable means for holding the portion 56 of the optical fiber to tension. Heat is applied, in accordance with the present invention, to one or more parts of the fiber portion 56. This results in the tuning of the interferometer arm.

Note that other portions of the arm may be held to tension if further tuning is required e.g. on the other side of the grating 54 to the portion 56.

The present invention may be applied in a similar manner to other Mach-Zehnder arrangements and to Michelson interferometer arrangements, and any other device requiring accurate setting of optical path length.

FIG. 7B illustrates a fiber-based Michelson interferometer 100 comprising a pair of fibers 150, 151 coupled through a 3 dB fused fiber coupler 152. A portion of each of the fibers 150, 151 comprises equal length fiber arms 153, 154, each arm having a fiber Bragg grating 155,156 of matched center wavelengths. A multiple channel signal λ₁ . . . λₙ input into fiber 150 is divided equally at the coupler 152 between the two arms 153, 154. A channel corresponding to the matched center wavelength of the fiber Bragg grating is reflected from both gratings 155,156 and output through fiber 151. The remaining channels are passed in equal portions through the gratings 155,156. It is essential that the arm lengths 153,154 are precisely equal in order for the reflected channel to be output from fiber 151. Similar to the Mach-Zehnder, a portion 158 of one or both arms 153,154 is held in tension by a device 157. Heat is applied in a controlled manner to the fiber portion 158 until the portion 158 relaxes sufficiently to tune the interferometer 100.

FIG. 7C illustrates a Sagnac interferometer 200 comprising a loop of optical fiber 250 joined at a 3 dB fused fiber coupler 252. A fiber Bragg grating 255 is located on the fiber loop exactly opposite the coupler 252, so that two lengths 253,254 of the loop are identical. A multiple channel signal λ₁ . . . λₙ input into fiber 250 passes through the loop and is reflected back out the input end 251, except for the channel corresponding to the fiber Bragg grating center wavelength, which is transmitted out fiber end 256. As described above, a portion 258 of one or both lengths 253,254 of optical fiber is held in tension by a device 257. Heat is applied in a controlled manner to the fiber portion 258 until the portion 258 relaxes sufficiently to tune the interferometer 200.

It will be appreciated by a person skilled in the art that numerous variations and/or modifications may be made to the present invention as shown in the specific embodiment without departing from the spirit or scope of the invention as broadly described. The present embodiment is, therefore, to be considered in all respects to be illustrative and not restrictive.

What is claimed is:

1. A method of tuning an optical fiber device, the fiber being held at a first tension, comprising the step of applying heat to the fiber to cause a release of tension to adjust the tension of the fiber to a second tension.

2. A method in accordance with claim 1, wherein the heat is applied to a localized area or localized areas of the fiber.

3. A method in accordance with claim 2, wherein a controller controls a heating device to apply heat to the optical fiber device.

4. A method in accordance with claim 3 wherein the controller controls the heat applied in response to a dynamic feedback control signal.

5. A method in accordance with claim 3, wherein the heating device comprises a laser of a wavelength that is absorbed to some degree by the optical fiber.

6. A method in accordance with claim 5, wherein the laser is a CO₂ laser.

7. A method in accordance with claim 3, wherein the heating device comprises a torch.

8. A method in accordance with claim 3, wherein heat is applied in such a manner as to result in tapering of the affected area of the fiber.

9. A method in accordance with claim 1, wherein the device is a fiber based interferometer.

10. A method in accordance with claim 1, wherein the device is an in-fiber Bragg grating.

11. An optical fiber device comprising:
an optical fiber;
a spaced apart pair of fixed supports for supporting a length of the optical fiber under tension, the length of optical fiber under tension including a portion exposed for heating, the portion having a taper,
whereby in response to heat on the portion of the length of optical fiber under tension, the tension can be controllably reduced to tune the optical fiber device.

12. An optical fiber device in accordance with claim 11, wherein the length of optical fiber under tension includes a fiber Bragg grating, and reducing the tension changes the resonant wavelength of the fiber Bragg grating.

13. An optical fiber device in accordance with claim 12, wherein the fiber Bragg grating is a long period grating.

14. An optical fiber device in accordance with claim 11 further including at least one additional fixed support, the fixed supports for supporting multiple lengths of the optical fiber under tension, and the multiple lengths of optical fiber under tension each include a fiber Bragg grating.

15. An optical fiber device in accordance with claim 11, wherein the optical fiber device comprises an interferometer and the length of optical fiber under tension comprises a portion of an interferometer arm, and reducing the tension changes the optical length of the interferometer arm.

16. An optical fiber device in accordance with claim 15, wherein the interferometer is selected from the group consisting of: a Mach-Zehnder interferometer, a Michelson interferometer, and a Sagnac interferometer.

17. A packaged optical device comprising:
an in-fiber optical device including an exposed portion for heating having a taper therein;
a package for hermetically sealing the in-fiber optical device,
a plurality of supports in fixed position within the container for supporting the in-fiber optical device under tension,
whereby the in-fiber optical device can be tuned by heating.

18. A packaged optical device in accordance with claim 17, wherein the package has a single uniform coefficient of thermal expansion.

19. A packaged optical device in accordance with claim 18, including a plurality of in-fiber optical devices each including an exposed portion for heating having a taper therein, and each supported by the plurality of supports under tension, whereby each in-fiber optical device can be tuned individually by heating.

20. A packaged optical device in accordance with claim 19 comprising a plurality of tuned-in fiber Bragg gratings mounted in a single package.

21. A packaged optical device in accordance with claim 20, wherein the plurality of tuned in-fiber Bragg gratings are provided in a plurality of fibers.

22. A packaged optical device in accordance with claim 20, wherein the plurality of tuned in-fiber Bragg gratings are provided in a single optical fiber.
